(19) United States
(12) Patent Application Publication
(10) Pub. No.: US 2025/0222681 A1
(43) Pub. Date: Jul. 10, 2025

(54) MOTOR VEHICLE PANE AND MOTOR VEHICLE HAVING SUCH A MOTOR VEHICLE PANE

(71) Applicant: Webasto SE, Stockdorf (DE)

(72) Inventors: Brad HEPNER, Macomb, MI (US); Suneel POSIMREDDY, Rochester Hills, MI (US); Ashish DUTT, Troy, MI (US); Tara HUSIC, Troy, MI (US)

(21) Appl. No.: 18/407,063

(22) Filed: Jan. 8, 2024

(51) Int. Cl. B32B 17/10; B60J 1/00; B60J 1/08; B60J 1/20

(52) U.S. Cl. CPC B32B 17/10036; B32B 17/10302; B32B 17/10779; B60J 1/006; B60J 1/2094; B32B 2250/02; B32B 2367/00; B32B 2605/00; B60J 1/08

(57) ABSTRACT

A motor vehicle pane having a glass pane. An anti-shatter composite substrate has at least two anti-shatter films firmly attached to the glass pane. The disclosure further relates to a motor vehicle having such a motor vehicle pane.

### FIELD

The present disclosure relates to a motor vehicle pane, in particular, for a passenger car having an anti-shatter composite substrate. Furthermore, the present disclosure relates to a motor vehicle having such a motor vehicle pane.

### BACKGROUND

Generic motor vehicle panes and motor vehicles comprising motor vehicle panes of this kind are known from the state of the art in different configurations.

The generic motor vehicle panes usually comprise a glass pane and an anti-shatter film firmly attached to the glass pane. The anti-shatter film is usually adhered to the glass pane.

When forces act on the motor vehicle pane, for example in the event of a traffic accident, this can cause the glass pane to break. When the glass pane breaks, the anti-shatter film and shields the occupant from direct exposure to glass fragments. This means that they mostly adhere to an adhesive surface of the anti-shatter film. The motor vehicle pane is destroyed in this case but mostly retains its original shape. In other words, the motor vehicle pane does not collapse. This increases the safety of an occupant in the vehicle interior since the occupant is not only protected from the individual glass fragments but also prevented from being ejected from the motor vehicle.

Various countries also define safety requirements for motor vehicle panes within the framework of standards that must be fulfilled in order for the motor vehicle to be approved.

For example, FMVSS 226 (Federal Motor Vehicle Safety Standard 226) specifies precise requirements for motor vehicle panes to reduce the likelihood of full or partial ejection of vehicle occupants in the event of rollovers or side impacts, which must be met for motor vehicle approval.

### SUMMARY

The object of the present invention is to provide a motor vehicle pane having an increased energy absorption capability compared to generic motor vehicle panes. Furthermore, the object of the present invention is to provide a motor vehicle comprising such a motor vehicle pane.

According to the invention, this object is attained by the motor vehicle pane having the features of a glass pane, wherein an anti-shatter composite substrate of the glass pane has at least two anti-shatter films firmly attached to the glass pane, and by the motor vehicle having a motor vehicle glass pane wherein an anti-shatter composite substrate of the motor vehicle glass pane has at least two anti-shatter films firmly attached to the motor vehicle glass pane.

Advantageous embodiments of the invention are the subject of the dependent claims.

All combinations of the features disclosed in the description, the claims and/or the figures fall within the scope of the invention. In particular, it is understood that linguistic reformulation and/or an analogous substitution of terms within the scope of common linguistic practice, in particular the use of synonyms supported by the generally accepted linguistic literature, are encompassed by the present disclosure without being explicitly mentioned in their respective formulations.

According to the invention, a motor vehicle pane, in particular for a passenger car, is proposed. The motor vehicle pane comprises a glass pane and an anti-shatter composite substrate firmly attached to the glass pane. The anti-shatter composite substrate comprises at least two anti-shatter films.

Thus, the core idea of the invention is to dispose at least two anti-shatter films on the glass pane. As a result, the motor vehicle pane according to the invention has a high energy absorption capability. This increases the safety of occupants in the motor vehicle.

In a preferred embodiment the motor vehicle pane is a window pane of a vehicular door and/or a window pane of a vehicular roof.

In a preferred embodiment of the motor vehicle pane according to the invention, the anti-shatter films comprise polyethylene terephthalate (PET). In particular, the anti-shatter films are each formed by thin PET films.

In an exemplary embodiment of the motor vehicle pane according to the invention, an adhesive film is disposed between adjacent anti-shatter films in each case. The adhesive film may connect the adjacent anti-shatter films to each other.

For example, the anti-shatter composite substrate comprises n anti-shatter films and (n−1) adhesive films.

In a preferred embodiment of the motor vehicle according to the invention, the anti-shatter composite substrate has a hard coat on a side facing away from the glass pane.

The hard coat protects the anti-shatter film furthest from the glass pane from scratching, for example.

Also, the hard coat may have such mechanical properties that an energy absorption capability of the motor vehicle pane according to the invention is further improved providing protection of the film layers from a vehicle interior impact.

In an exemplary embodiment of the motor vehicle pane according to the invention, the anti-shatter composite substrate comprises a plurality of anchoring holes in an edge area.

For example, the anchoring holes are through holes, i.e., holes extending through the entire anti-shatter composite substrate, in particular in a direction orthogonal to a motor vehicle pane transverse direction or from a motor vehicle interior toward a vehicle exterior.

In an exemplary embodiment, the motor vehicle pane according to the invention comprises an adhesive bead, i.e., a continuous strand of glue.

The adhesive bead has a closed shape, for example.

The geometry of the adhesive bead may correspond to or resemble an outer geometry of the anti-shatter composite substrate.

In a preferred embodiment of the motor vehicle pane according to the invention, the adhesive bead extends through the anchoring holes, in particular completely.

The adhesive bead can thus be applied to the anti-shatter composite substrate in such a manner on a side facing away from the glass pane that the adhesive bead completely fills the anchoring holes and is in contact with the glass pane in the anchoring holes. The anti-shatter composite substrate is, thus, additionally attached to the glass pane.

In an exemplary embodiment of the motor vehicle pane according to the invention, an edge area of the anti-shatter composite substrate, in particular of the side of the anti-shatter composite substrate facing away from the glass pane, is covered, in particular completely, by the adhesive bead.

The anchoring holes are disposed in the edge area, for example.

In a preferred embodiment of the motor vehicle pane according to the invention, the adhesive bead circumferentially surrounds the anti-shatter composite substrate. The adhesive bead, thus, is in contact with a lateral surface of the anti-shatter composite substrate, in particular across the entire circumference.

The adhesive bead is in contact with the circumference of the glass pane. The anti-shatter composite substrate is, thus, additionally attached to the glass pane.

On a side of the adhesive bead facing away from the glass pane, a mounting frame can be attached to the adhesive bead.

The mounting frame can be used to connect further components of the motor vehicle.

In an exemplary embodiment of the motor vehicle pane according to the invention, the mounting frame covers an entire side of the adhesive bead facing away from the glass pane. The adhesive bead thus forms a cover element with the result that the adhesive bead is no longer visible, i.e., concealed, after the mounting frame has been attached. This results in an attractive visual appearance of the motor vehicle pane as viewed from the motor vehicle interior and protects the adhesive bead.

In an exemplary embodiment of the motor vehicle pane according to the invention, the anchoring holes each have the shape of a rectangle with rounded corners.

The anchoring holes may have the shape of a rectangle with semicircles adjoining each end thereof. The corners of the rectangle may thus be rounded in such a manner that two adjacent corners together form a semicircle in each case.

In a preferred embodiment of the motor vehicle pane according to the invention, the anchoring holes are approximately 11 mm, in particular 11 mm±0.3 mm, long. This size varies with glass pane thickness and surrounding mounting frame for optimal anchoring.

The anchoring holes may be about 5 mm, in particular 5 mm±0.3 mm, wide. This size varies with glass pane thickness and surrounding mounting frame for optimal anchoring.

In a preferred embodiment of the motor vehicle pane according to the invention, the anchoring holes are each spaced apart from an edge of the anti-shatter composite substrate by approximately 3 mm, in particular 3 mm±0.3 mm. This size varies with glass pane thickness and surrounding mounting frame for optimal anchoring.

In a preferred embodiment of the motor vehicle pane according to the invention, the anchoring holes are each spaced apart from each other by about 4 mm, in particular 4 mm±0.3 mm. This size varies with glass pane thickness and surrounding mounting frame for optimal anchoring.

In an exemplary embodiment of the motor vehicle pane according to the invention, the anti-shatter composite substrate is attached to the glass pane via an adhesive layer.

The anti-shatter films, the adhesive films and/or the adhesive layer are transparent, for example.

The anti-shatter composite substrate may be attached to a side of the glass pane which faces a motor vehicle interior in a functionally correct installed state of the motor vehicle pane in the motor vehicle.

In a preferred embodiment of the motor vehicle pane according to the invention, the motor vehicle pane is a side window of the motor vehicle. The motor vehicle pane can thus increase the safety for occupants of the motor vehicle, in particular in the event of a side crash.

Furthermore, the invention relates to a motor vehicle, in particular a passenger car, comprising at least one window as described above.

The window may be a side window of the motor vehicle.

Further advantages and advantageous embodiments of the subject matter of the invention are apparent from the description, the drawing and the claims.

An embodiment example of a motor vehicle comprising a motor vehicle pane according to the invention schematically illustrated in the drawing and will be explained in more detail in the following description.

### BRIEF DESCRIPTIONS OF THE DRAWINGS

FIG. 1 is a schematic side view of a motor vehicle according to the invention;

FIG. 2 is a schematic side view of a glass pane and an anti-shatter composite substrate of a motor vehicle pane of the motor vehicle according to the invention;

FIG. 3 shows a cross-sectional edge area through the motor vehicle pane; and

FIG. 4 is a detailed view of an edge area of the anti-shatter composite substrate.

### DETAILED DESCRIPTION

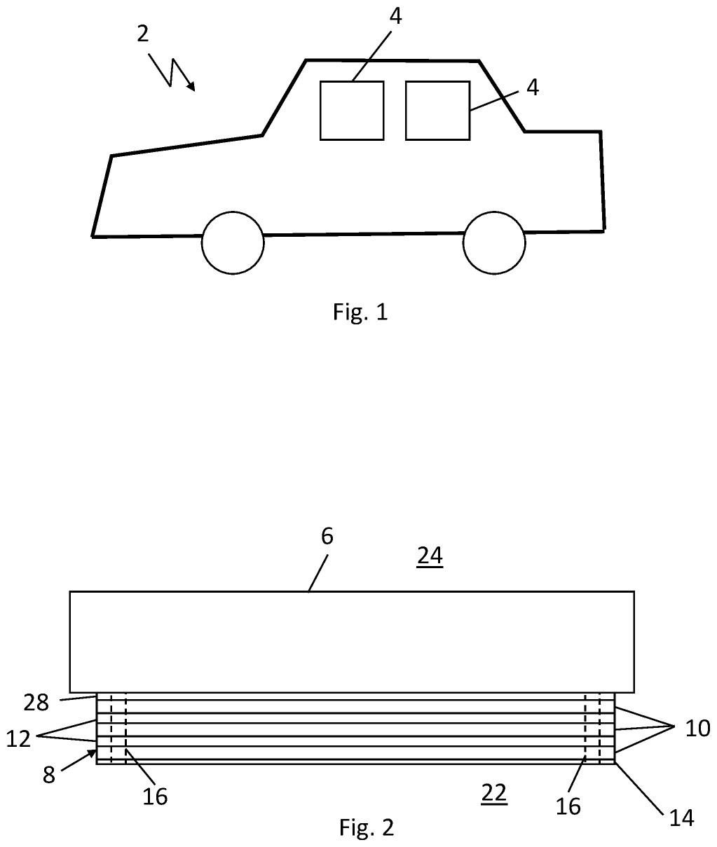

FIG. 1 shows a motor vehicle 2 according to the invention. The motor vehicle 2 is a passenger car.

The motor vehicle 2 comprises motor vehicle panes 4, which are side windows of the motor vehicle. The motor vehicle panes 4 each comprise a glass pane 6 and an anti-shatter composite substrate 8. The anti-shatter composite substrate 8 is firmly attached to a side of the glass pane 6 facing a motor vehicle interior 22 via an adhesive layer 28. The glass pane 6 thus faces a motor vehicle exterior 24.

The anti-shatter composite substrate 8 comprises a plurality of anti-shatter films 10 and adhesive films 12. In particular, the anti-shatter composite substrate 8 comprises n anti-shatter films 10 and (n−1) adhesive films 12. As can be seen from FIG. 2 in particular, the anti-shatter composite substrate 8 shown in the Figures comprises three anti-shatter films 10 and two adhesive films 12.

The adhesive films 12 are each disposed between adjacent anti-shatter films 10 and connect them to each other across their entire surface (see FIG. 2). So the adhesive films 12 are of the same length and width as the anti-shatter films 10.

On a side facing away from the glass pane 6, the anti-shatter composite substrate 8 comprises a hard coat 14. The hard coat 14 protects the anti-shatter composite substrate 8 from scratching and further increases a rigidity of the anti-shatter composite substrate 8 by providing protection of the film layers from a vehicle interior impact.

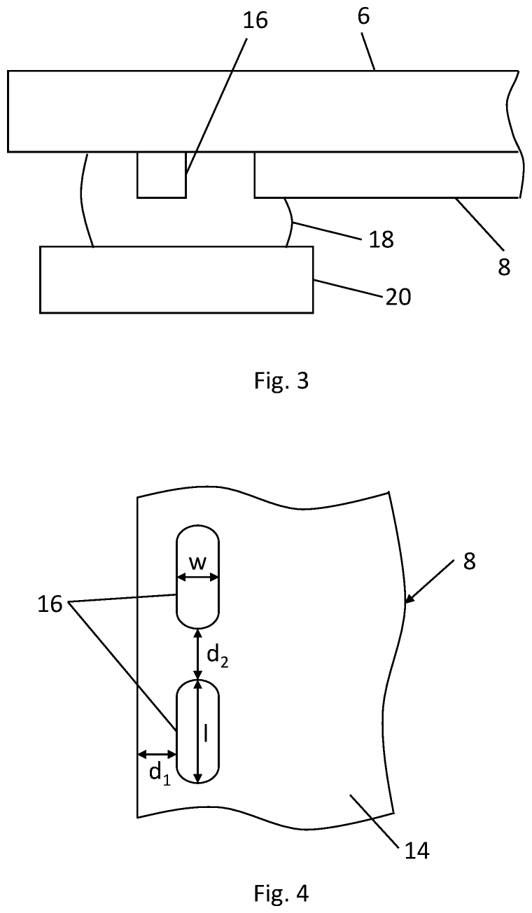

As can be seen from FIGS. 3 and 4 in particular, the anti-shatter composite substrate 8 has anchoring holes 16 in an edge area. The anchoring holes 16 are through holes, i.e., holes which extend through the entire anti-shatter composite substrate 8, in particular in a direction orthogonal to an extension direction of the motor vehicle pane 4 or from the motor vehicle interior 22 in the direction of the motor vehicle exterior 24; in the case at hand, they extend in the transverse direction of the motor vehicle.

The anchoring holes 16 each have the shape of a rectangle with rounded corners. The corners of the rectangle are rounded in such a manner that the rectangle is semicircular at the ends.

In the edge area of the anti-shatter composite substrate 8 comprising the anchoring holes 16 and at the circumference, the anti-shatter composite substrate 8 is surrounded by an adhesive bead 18. The adhesive bead 18 is attached to the anti-shatter composite substrate 8 in such a manner that the adhesive bead 18 completely fills the anchoring holes 16. The adhesive bead 18 thus is in contact with the glass pane 6 both in the anchoring holes 16 and at the circumference of the anti-shatter composite substrate 8. The anti-shatter composite substrate 8 is thus additionally attached to the glass pane 6 via the adhesive bead 18.

The adhesive bead 18 forms a continuous adhesive element, which completely surrounds the anti-shatter composite substrate 8. So the adhesive bead 18 has no interruptions and forms a closed ring element, in particular with a shape corresponding to the outer geometry of the anti-shatter composite substrate 8.

On a side of the adhesive bead 18 facing away from the glass pane 6, i.e., on a side facing the vehicle interior 22, a mounting frame 20 is disposed on the adhesive bead 18. The mounting frame 20 is attached to the adhesive bead 18 in such a manner that the adhesive bead 18 is not visible when viewed from a motor vehicle interior 22. So the mounting frame 20 completely covers the adhesive bead 18 in the direction of the motor vehicle interior 22 and forms a kind of screen element which ensures an attractive visual appearance of the motor vehicle pane 4 when viewed from the motor vehicle interior 22.

Via the mounting frame 20, further components (not shown) of the motor vehicle 2 can be attached to the vehicle or the vehicle body via the motor vehicle pane 4. The anchoring holes are spaced apart from one another in a second distance d2 by approximately 4 mm. The anchoring holes 16 are each spaced apart from an edge of the anti-shatter composite substrate 8 in a first distance d1 by approximately 3 mm but can vary by the mounting frame packaging space available. The anchoring holes 16 are each about 11 mm 1 long and have a width w of about 5 mm. This size varies with glass pane thickness and surrounding mounting frame for optimal anchoring.

### REFERENCE SIGNS

2 motor vehicle
4 motor vehicle pane
6 glass pane
8 anti-shatter composite substrate
10 anti-shatter film
12 adhesive film
14 hard coat
16 anchoring holes
18 adhesive bead
20 mounting frame
22 vehicle interior
24 vehicle exterior
26 lateral edge
28 adhesive layer
d₁ distance from the anchoring hole to the side edge
d₂ distance between adjacent anchoring holes
l length of the anchoring holes
w width of the anchoring holes

1. A motor vehicle pane, comprising: a glass pane, wherein an anti-shatter composite substrate of the glass pane comprises at least two anti-shatter films firmly attached to the glass pane.

2. The motor vehicle pane according to claim 1, wherein the anti-shatter films are polyethylene terephthalate films.

3. The motor vehicle pane according to claim 1, wherein an adhesive film is disposed between adjacent anti-shatter films in each case.

4. The motor vehicle pane according to claim 1, wherein the anti-shatter composite substrate has a hard coat on a side facing away from the glass pane.

5. The motor vehicle pane according to claim 1, wherein the anti-shatter composite substrate comprises anchoring holes in an edge area.

6. The motor vehicle pane according to claim 5, wherein the anchoring holes are through holes.

7. The motor vehicle pane according to claim 5, wherein an adhesive bead extends through the anchoring holes and covers the edge area of the anti-shatter composite substrate.

8. The motor vehicle pane according to claim 7, wherein the adhesive bead circumferentially surrounds the anti-shatter composite substrate.

9. The motor vehicle pane according to claim 7, wherein a mounting frame is attached to the adhesive bead.

10. The motor vehicle pane according to claim 9, wherein the mounting frame covers the entire side of the adhesive bead facing away from the glass pane.

11. The motor vehicle pane according to claim 5, wherein the anchoring holes each have the shape of a rectangle with rounded corners.

12. The motor vehicle pane according to claim 5, wherein the anchoring holes have a length of 11 mm±0.3 mm and/or a width of 5 mm±0.3 mm.

13. The motor vehicle pane according to claim 5, wherein the anchoring holes are spaced from the edge of the anti-shatter composite substrate by a first distance by 3 mm±0.3 mm and/or from each other by a second distance by 4 mm±0.3 mm.

14. The motor vehicle pane according to claim 1, wherein the motor vehicle pane is a side window of a motor vehicle.

15. A motor vehicle comprising a motor vehicle pane according to claim 1.
